(19) United States
(12) Patent Application Publication
(10) Pub. No.: US 2016/0356055 A1
(43) Pub. Date: Dec. 8, 2016

(54) COLUMBARIUM SYSTEM WITH TEMPORARY NICHE COVER

(71) Applicant: Eickhof Columbaria, Inc., Crookston, MN (US)

(72) Inventor: David J. Trousil, Crookston, MN (US)

(21) Appl. No.: 15/148,530

(22) Filed: May 6, 2016

Related U.S. Application Data
(60) Provisional application No. 62/159,096, filed on May 8, 2015.

(51) Int. Cl. E04H 13/00; F16B 5/02

(52) U.S. Cl. CPC E04H 13/006; E04H 13/001; F16B 5/0266

(57) ABSTRACT

A columbarium includes a plurality of niches configured to store cremated remains. Temporary stone cover panels mount to the front of the niches and panel retainer assemblies, each having a bracket mounted on the back of the cover panel; the bracket having an orifice formed therein. A retainer element has an engagement portion extending through the orifice of the bracket and projecting from the bracket. The retainer element is supported on the retainer element spaced apart from the cover panel and extending along the back of the cover panel. A spring engages the bracket and the retainer element to maintain the retainer element in position. The temporary cover panel is compared to the permanent cover panel and the spring-loaded adjustable hardware of the temporary cover panel is released and the position of the spring-loaded adjustable hardware of the temporary cover panel is adjusted to match the complementary hardware of the permanent cover panel.

### BACKGROUND OF THE INVENTION

Field of the Invention

The present invention relates to a system for mounting temporary niche cover panels and a method for replacing panels.

Description of the Prior Art

Columbarium structures are utilized to store cremated remains as a less expensive alternative to traditional burials. Such columbarium installations include multiple storage niches for storing urns or other receptacles. The niches include stone shutters or panels covering the niche compartments in a respectful manner to provide dignified interment.

As access is required for placing the remains in the niche, the stone cover panels, also commonly referred to as shutters, are removably secured to the columbarium structure using a mounting system that is preferably concealed or substantially hidden from view so that the hardware does not detract from the appearance of the stone and the dignified appearance of the columbarium. Such systems are weather resistant and configured to hold the shutters in position despite variations in temperature and harsh weather conditions. Examples of such hardware systems are shown in U.S. Pat. Nos. 4,644,711, 5,802,781, and 8,122,650, all owned by Eickhof Columbaria, LLC. The hardware generally provides for an aesthetically pleasing appearance of the stone facing panels with the hardware substantially hidden from view. Moreover, the mounting hardware allows for simple and straight forward installation and removal of the facing panels.

Although the niches generally have the same shape, it can be appreciated however that there may be slight variations from panel to panel and installation to installation. Stone and particularly granite is a popular and widely used material for facing panels as it has a pleasing appearance and is durable. However, due to its extreme hardness, granite is difficult to work with may not be cut to exact dimensions with great precision. Therefore, there may be slight variations in the thickness of the panels as well as the height and width. Mounting hardware of Eickhof Columbaria, Inc. has been developed that provides infinite adjustment to mount the facing panels so that all are properly aligned and flush.

A typical columbarium structure will initially have the stone facing panels without inscriptions but that the panels will need to be removed to add inscriptions, to update information or if additional remains are added to a niche, to add names and information. During such tasks the niche must be covered while the permanent stone panel is being inscribed. Therefore, temporary panels are used, preferably of the same outer material as the original shutter. However, due to slight variations such as mounting position or other configuration characteristics, the hardware and spacing of the temporary cover panel may not necessarily align properly with the hardware of the existing panel that it is replacing. Therefore, there may be problems with installing the temporary panel. Moreover, a temporary cover must provide sufficient security to the contents of the niche while the permanent cover panel is being inscribed.

It can therefore be appreciated that a new and improved system for mounting a temporary niche stone cover panel for a columbarium is needed. Such a system should provide for infinite adjustment of the mounting hardware of the temporary panel to fit the complementary hardware of the niche. Such a system should provide for using the same hardware with easy, simple, quick and precise adjustment and for maintaining the panels in proper alignment relative to the panels of adjacent niches. The present invention addresses these problems as well as others associated with temporary niche facing panels.

### SUMMARY OF THE INVENTION

The present invention is directed to a temporary cover panel for a columbarium and to a method for mounting a temporary cover panel on a columbarium. The columbarium includes an array of niches. Each niche is covered by a decorative stone shutter, also known as a facing panel.

The stone shutters may be configured for covering a single niche or may cover multiple niches and divided into quadrants corresponding to the niches and include information correspond to the each of the niches being covered. A frame and other materials are be made of materials that will not rust, corrode, or degrade over extended periods of time, such as is required for a columbarium exposed to the elements. An inner cover may fit into a groove and may be removably attached for providing additional privacy and sealing of the interior of each niche.

When one of the covers must be removed for engraving or other tasks, temporary cover is placed on the niche. The temporary cover panel includes an exposed front, and a back configured to face the niche. The temporary cover panel includes corresponding panel retainer assemblies. The temporary panel retainer assemblies each include a bracket mounted on the back of the temporary stone cover panel and having and an orifice formed therein. A retainer element, such a bolt, includes a threaded engagement portion extending through the orifice of the bracket and projecting from the bracket. The bolt is supported on the retainer element spaced apart from the panel and extending substantially parallel to the back of the panel. A spring member engages the bracket and the retainer element.

To mount the temporary stone cover panel, the permanent cover panel is removed from the niche. The temporary cover is compared to the permanent cover, releasing the spring-loaded infinitely adjustable complementary hardware of the temporary cover and adjusting the spring-loaded adjustable hardware of the temporary cover while released to match the complementary hardware of the permanent cover. The process is repeated for each of the temporary hardware mounting assemblies so that the temporary mounting hardware matches the position of the corresponding hardware on the permanent niche cover panel. The temporary niche cover is placed on the niche compartment with the spring-loaded adjustable hardware engaging the complementary mounting hardware of the niche.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings, wherein like reference numerals and letters indicate corresponding structure throughout the several views:

FIG. 1 is a perspective view of a columbarium according to the principles of the present invention;

FIG. 2 is a side sectional view of the columbarium shown in FIG. 1;

FIG. 3 is a side sectional view of two niches and covers for the columbarium shown in FIG. 1;

FIG. 4 shows a side elevational view of a temporary cover panel for the columbarium shown in FIG. 1;

FIG. 5 is a rear elevational view of a permanent cover panel beside a temporary cover panel for the columbarium shown in FIG. 1;

FIG. 6 shows a side elevational view of an adjustable mounting device for the temporary cover shown in FIG. 3;

FIG. 7 shows a rear elevational view of the adjustable mounting device shown in FIG. 6;

FIG. 8 is a top plan view of a bracket for the adjustable mounting device shown in FIG. 6;

FIG. 9 is a front elevational view of the bracket shown in FIG. 8;

FIG. 10 is a side elevational view of the bracket shown in FIG. 8;

FIG. 11A shows a front elevational view of the adjustable mounting device shown in FIG. 6 and FIG. 11B shows the adjustable mounting device with the bolt depressed for adjustment;

FIG. 12A shows a side sectional view of the adjustable mounting device shown in FIG. 11A and FIG. 12 B shows a side sectional view the adjustable mounting device shown in FIG. 11B; and

FIG. 13 shows a side sectional view of the adjustable mounting device shown in FIG. 11A with adjustment shims for setting the position of the bolt.

### DETAILED DESCRIPTION OF THE PREFERRED EMBODIMENT

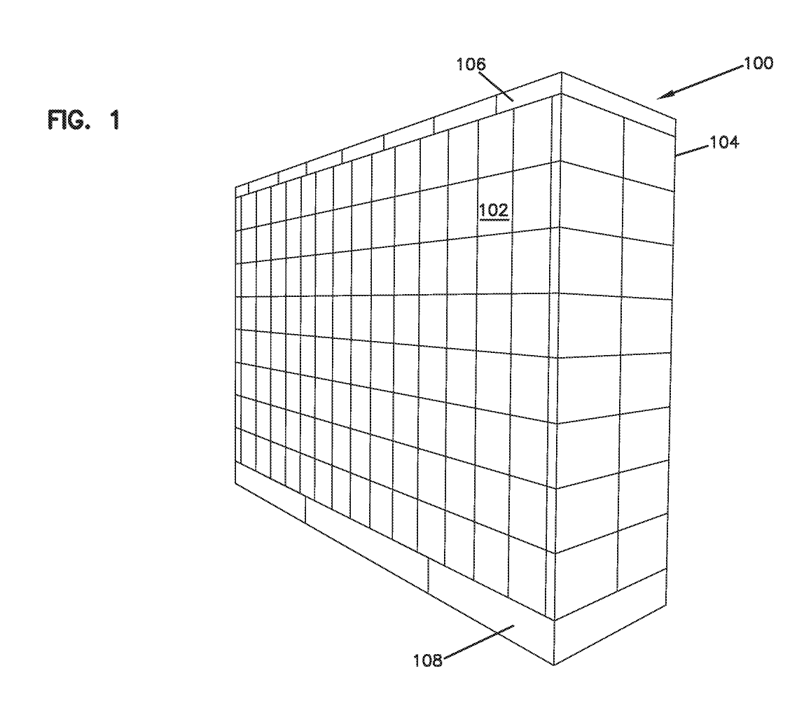

Referring now to the drawings and in particular to FIG. 1, there is shown a columbarium, generally designated 100. The columbarium 100 may take on a variety of different sizes and configurations, but typically includes an array of niches 102 aligned vertically and horizontally. Planar and curved wall configurations are possible and different columbarium structures may be grouped together in a single installation.

Each of the individual niches 20 is covered by a stone shutter or facing panel 102. In a typical installation, the columbarium 100 includes sides 104 also with a stone facing, a cap stone 106 and a base 108. It is envisioned that in many installations, exposed surfaces will be covered with a decorative stone, such as marble or granite depending on the location and exposure of the installation.

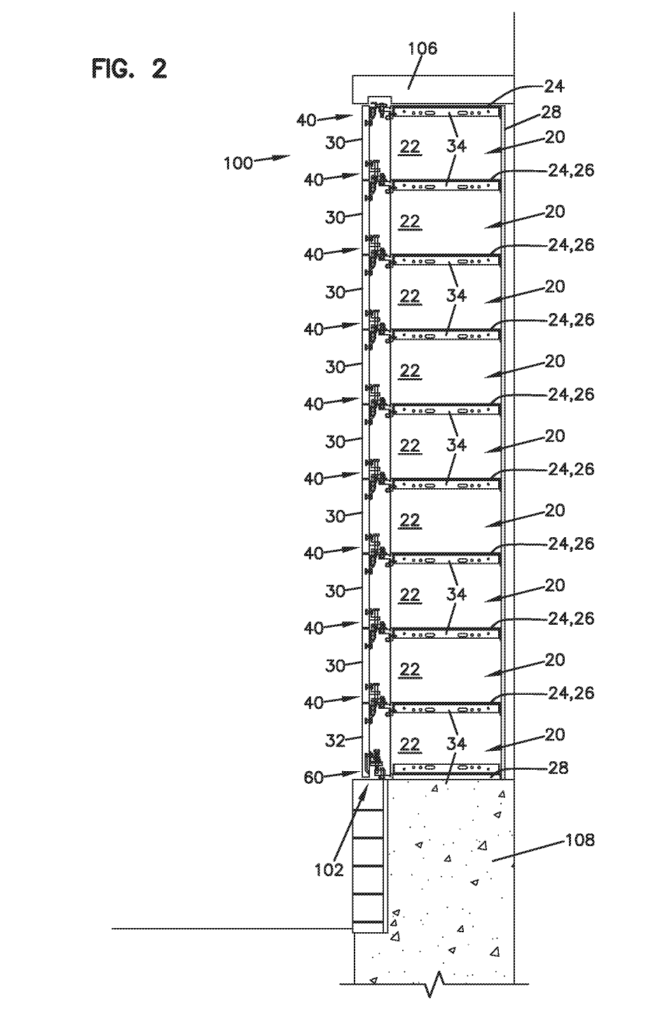

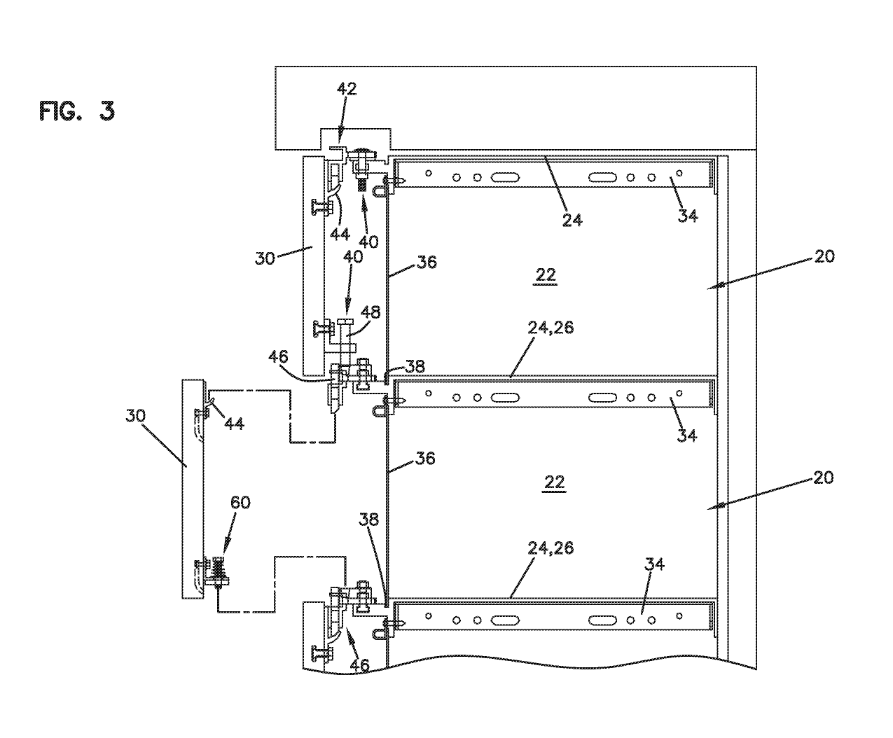

Referring now to FIGS. 2 and 3, each of these niches 20 includes opposed sidewalls 22. A top 24 and a bottom 26 along with rear 28 and cover panels or shutters 30 define an interior storage space capable of storing remains. The size of the niche 20 may vary and be divided depending on the needs to store one or more sets of remains. The stone shutters or covers 30 may be configured for covering a single niche 20 or may cover multiple niches. For example, a single stone shutter 30 covering four niches 20, but may include four different quadrants corresponding to the niches 20 and include information correspond to the each of the niches being covered. A frame 34 is constructed with mounting elements to adapt to various configurations and provide a structurally sound, lightweight and weather resistant structure. The frame and other materials may be made of materials that will not rust, corrode, or degrade over extended periods of time, such as is required for a columbarium exposed to the elements. In addition, an inner cover 36 fits into a groove 38 and may be removably attached for providing additional privacy and sealing of the interior of each niche 20.

Mounting hardware, generally designated 40, mounts to a front portion of the top 24 and/or bottom 26 extends outward beyond the interior cover 36. The mounting hardware includes a release mechanism 42, and a top hook element 44 mounting to the removable stone cover panel 30. Bottom receivers 46 each receive an adjustable bottom engagement assembly 48. A bracket 52 mounts to the bottom of the stone cover panel 30 and includes a threadably connected peg 50 that engages the receivers 46. The mounting hardware 40 is adjustable at both the top and bottom to ensure that the shutters 30 are properly aligned and spaced to provide a more aesthetically pleasing appearance.

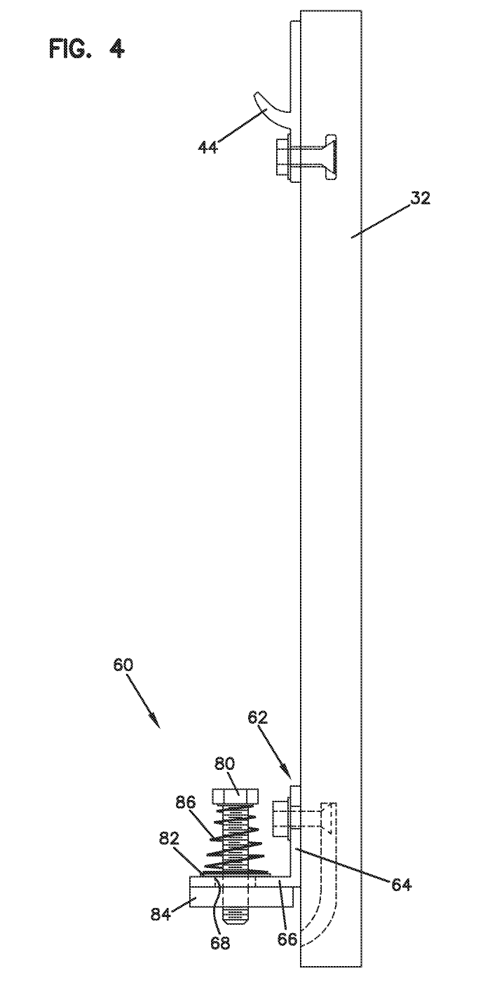

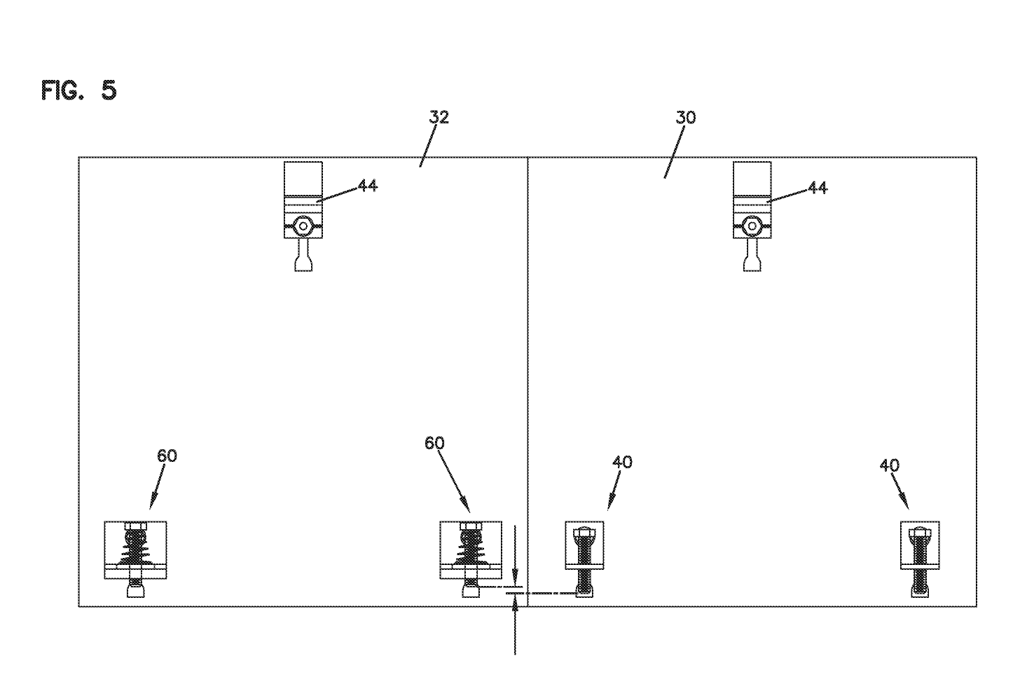

Referring now to FIG. 4, there is shown a temporary stone cover panel 32 including easily adjustable mounting hardware 60. The hardware 60 can be easily adjusted to a range of infinite different positions in a short period of time so that the replacement niche cover 32 can be used while other covers 30 are removed, such as may be required by being engraved. The adjustable hardware assembly includes a bracket 62 including a mounting section 64 and a bolt receiving section 66. The receiving section 66 includes a hole 60 through which a bolt 80 extends. The bracket 62 is mounted to the back of the niche 32 with a mounting screw 74 including a nut 76 and washer 78. A slot 70 is formed in the back surface and substantially parallel to the back surface of the niche includes a widened portion shown most clearly in FIG. 5. The widened portion 72 allows for the head of the bracket mounting screw 74 to be inserted into the slot 70. The bracket 62 may be positioned relative to the niche 32 and then retained in place by tightening the nut 76 onto the mounting screw 74. Although the bracket 62 may be adjusted by loosening the mounting screw 74 and nut 76, it is envisioned that most adjustment will be made by changing the position of the bolt 80. As shown in FIG. 5, the typical temporary niche 32 includes two adjustable hardware assemblies 60 corresponding to bottom engagement assemblies 48 on a conventional stone shutter 30.

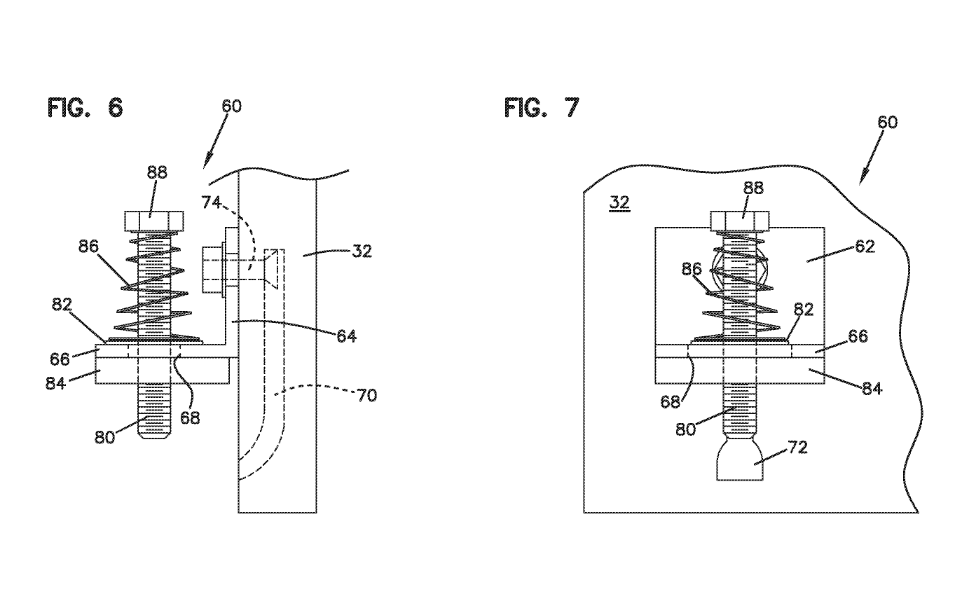

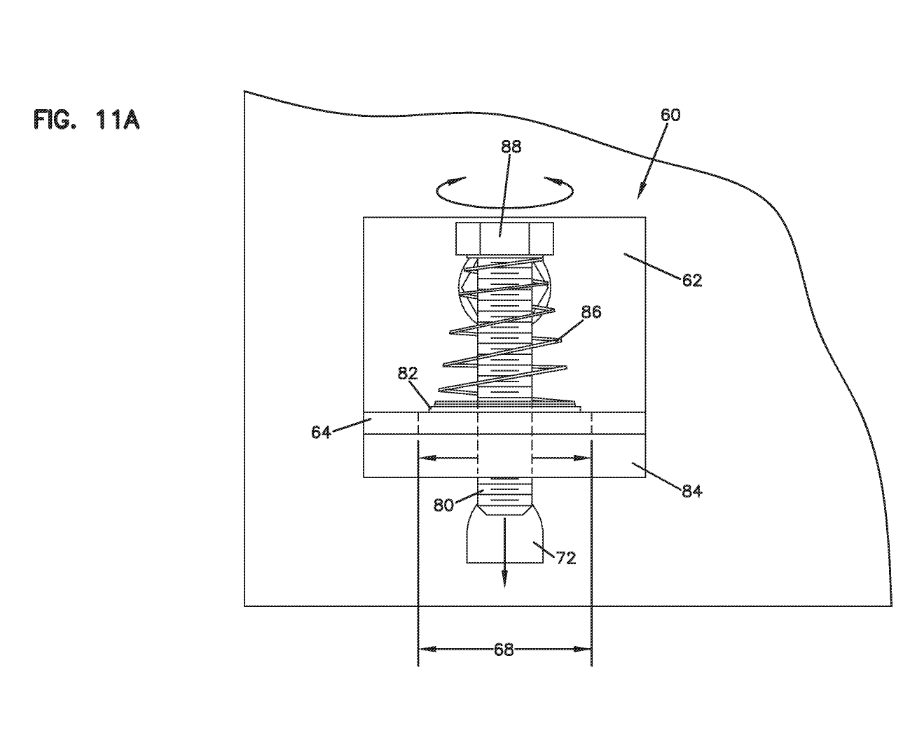

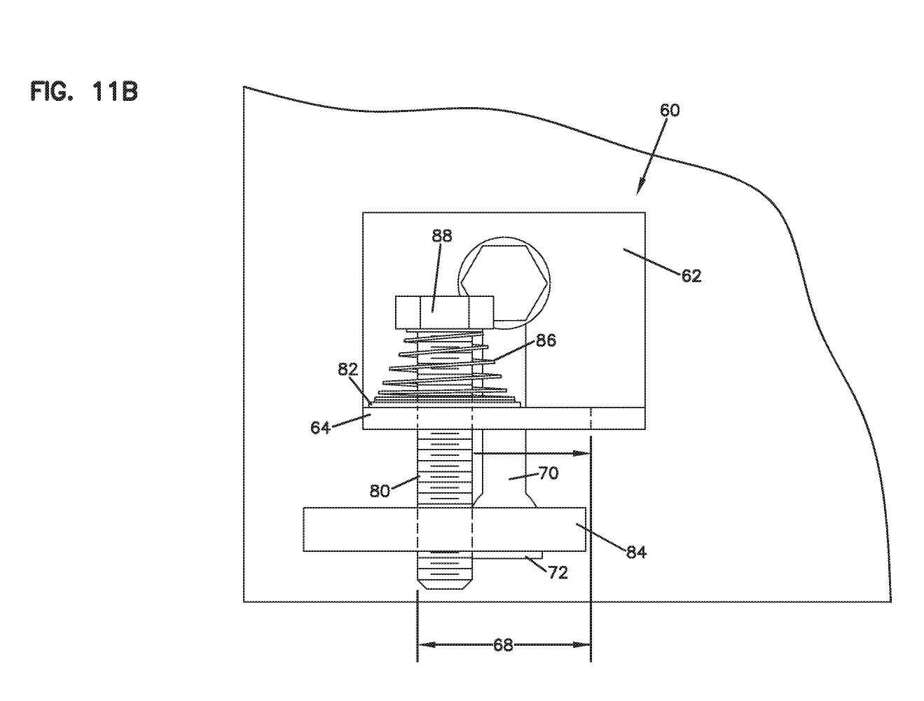

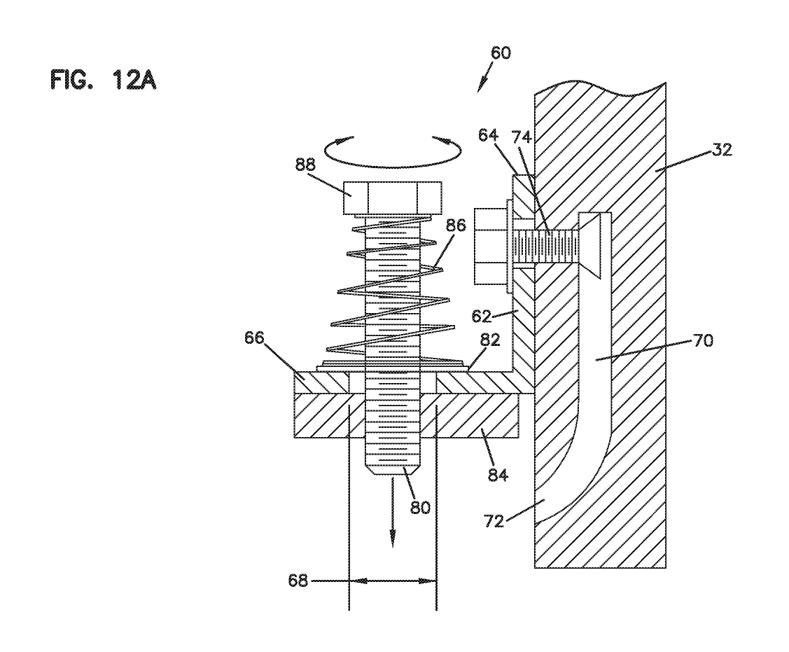

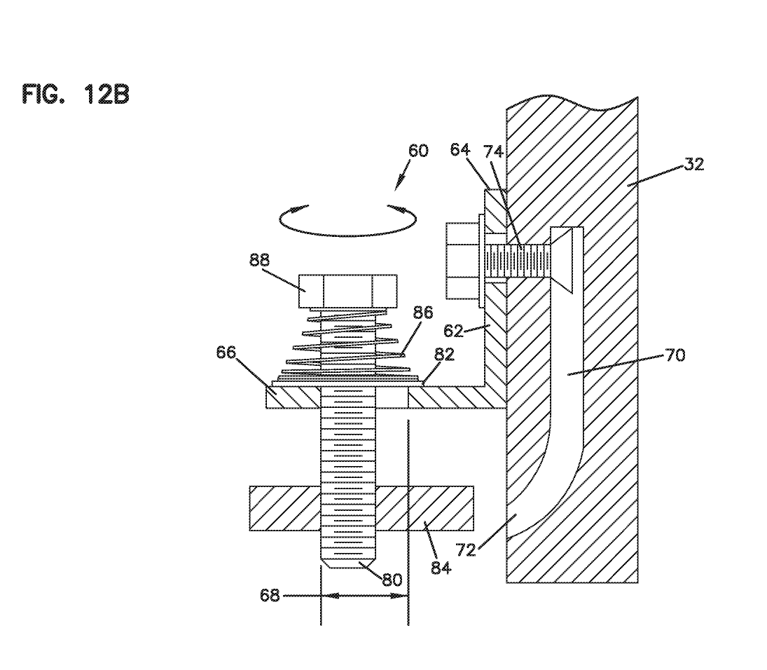

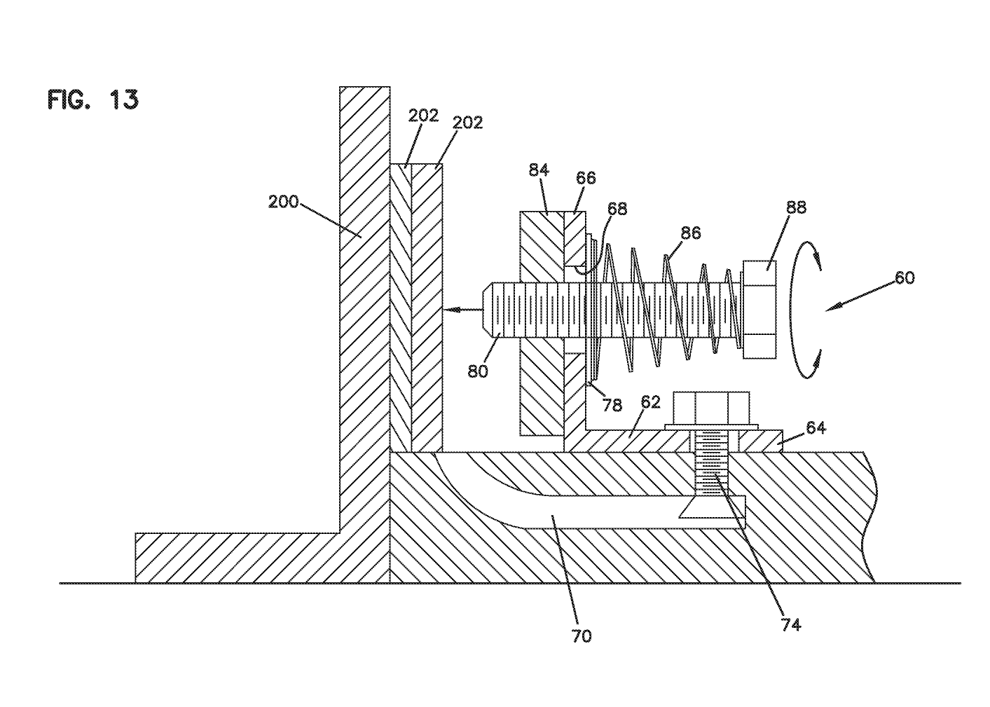

As shown most clearly in FIGS. 6, 7, 11A, 11B, 12A and 12B, the engagement bolt 80 is configured to engage the complementary receiver 46 mounted to the columbarium, shown in FIG. 3. The bolt 80 extends through the mounting hole 68 of the bracket 62 and includes a nut 84 threadably attached on the bolt 80. A washer 82 is mounted in an opposite side of the receiving section 66 of the bracket 62. A compressible spring inserts intermediate a head 88 of the bolt 80 and the washer 82. In such a spring-loaded configuration, the spring 86 is biased against the bolt 88 and the washer 82 to push the head away from the receiving section 66 of the bracket 62 and to pull the nut 84 into engagement with an underside of the receiving section 66. The spring constant of the spring 86 is such that the is sufficiently stiff to hold the bolt 80 in the position shown in FIGS. 6 and 7 even while supporting the weight of the temporary niche 32. However, it can also be appreciated that the spring constant is not too high and provides for manually compressing the spring 86 to release bolt 80 for adjustment, as shown in FIGS. 11B and 12B. It can be appreciated that, like the permanent mounting hardware, the temporary adjustable hardware 60 is also substantially hidden from view when installed and provides an aesthetically pleasing appearance.

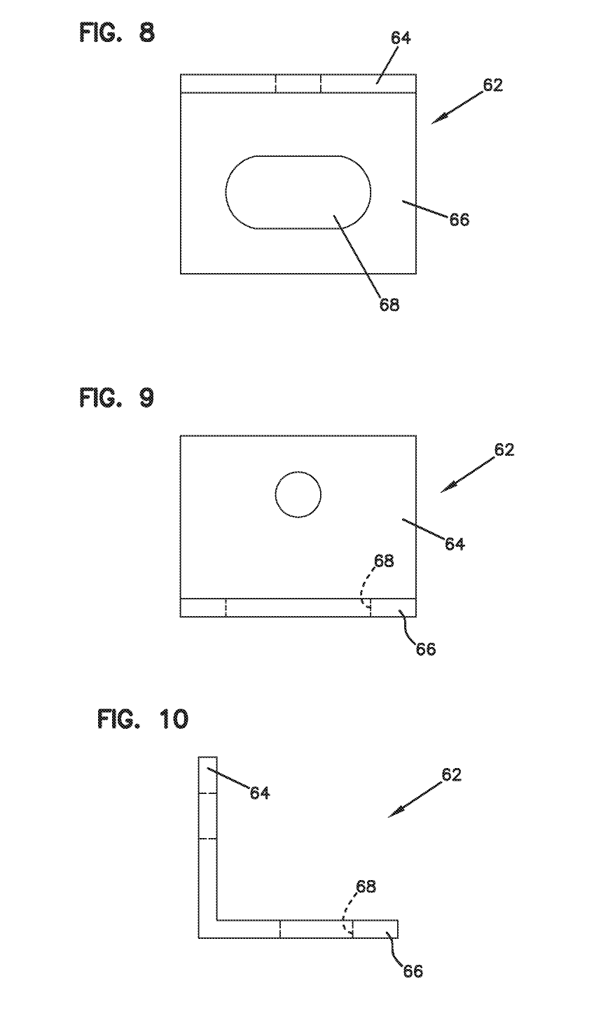

As the receiving hole 68 in the bracket receiving portion 66 is much larger than the diameter of the bolt 80, the relative position of the bolt 80 to the receiving portion 66 of the bracket 62 may be altered. Therefore, position the bolt 80 relative to the temporary shutter 32 may also be changed. When depressed, the bolt 80 may be moved toward and away from the rear of the temporary shutter 32. Moreover, the bolt 80 may be laterally in the hole 68. As it is envisioned that more side-to-side adjustment may be required, the hole 68 may have an oblong configuration as shown in FIG. 8. Furthermore, the bolt 80 may be adjusted vertically by simply twisting the bolt 80 relative to the nut 84 to change the final position of the bolt 80 relative to the mounting bracket 62 and therefore the final position of the bottom end of the bolt 80 for engagement with the receivers 46 of each niche 20.

To remove one of the niche cover panels 30 and replace it with a temporary panel 32, the release mechanism 42 is actuated with a tool configured to extend through the space above the niche and release the top hardware. Such a system is described in U.S. Pat. No. 8,122,650, incorporated herein by reference. The niche cover panel 30 may then be pivoted downward on the lower mounting hardware and then lifted off from the columbarium 100. Following removal, the niche cover panel 30 is placed beside the temporary cover panel 32. A positioning element 200 is then placed against the bottom of the niche 30 and spacers such as shims are inserted until the gap between the element 200 and the peg 50 is filled. The positioning element 200 and the shims are then moved to the corresponding adjustable hardware 60 and the bolt 80 is twisted clockwise or counter clockwise, depending on whether it is to be moved up or down until it just engages the shims 202. In this manner, the vertical position of the bolt 80 matches the vertical position of the peg 50. The process is then repeated for the other adjustable hardware assembly 60 to match the position on the cover panel 30. In addition, the distance between the peg 50 and the rear of the stone shutter 30 is measured and the bolt 80 is pushed to compress the spring and release the bolt 80 to move into a corresponding position. Similarly, the relative lateral position of the bolt is measured and the bolt moved to the correct lateral position depressing the spring and moving the bolt along with its washer, spring, and nut. The threaded bolt 80 allows for vertical adjustment while the compressed spring along with the nut, washer and bracket 62 with an enlarged hole 68 allow the bolt 80 to be moved toward and away from the temporary stone shutter 32 and laterally along the shutter 32 to match the position of the peg 50 of the original shutter 30. When both of the adjustable hardware assemblies 60 are correctly aligned to match the hardware of the permanent niche cover shutter 30, the temporary cover panel 32 may be installed. The process is repeated for the second adjustable hardware assembly 60. The temporary cover 32 is installed by placing the bolts 80 into the corresponding receivers 46 and tilting the temporary stone panels 32 into the vertical position. The release mechanism 42 is then engaged so that the top hook element is retained. When the top hook element is properly retained, the temporary cover 32 is securely mounted to the columbarium 100.

It can be appreciated that when the permanent niche cover panel 30 is replaced, the temporary cover panel 32 may be easily removed by simply engaging the release mechanism 42 and pivoting the temporary cover stone cover panel 32 downward in the same manner used for removing the permanent stone cover panel 30. Moreover, it can be appreciated that the temporary cover 32 may be used for temporarily replacing other permanent niche covers 30 with adjustments being made to properly match the positioning for each installation. Therefore, one or only a few temporary panels may be utilized to fill the spaces when the permanent stone cover panels 30 are removed for engraving or other reasons. The use of such temporary cover panels 32 achieves a more aesthetically pleasing appearance and greater security than having to leave the niches without a stone cover panel or requiring more time-consuming adjustment by using a replacement permanent panel 30.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A cover for a niche, comprising:
a panel having an exposed front, and a back configured to face a niche;
a plurality of panel retainer assemblies, at least one of the panel retainer assemblies comprising:
a bracket mounted on the back of the panel and having a first side, a second side, and an orifice formed therein;
a retainer element, the retainer element having an engagement portion extending through the orifice of the bracket and projecting from a first side of the bracket and supported on the bracket spaced apart from the panel and extending along the back of the panel; and
a biasing member on the second side of the bracket and engaging the bracket and the retainer element.

2. A cover according to claim 1, wherein the bracket comprises a support portion extending transversely to the back of the panel and having the orifice formed therein.

3. A cover according to claim 1, wherein the orifice has a height and width greater a height and width of the retainer element.

4. A cover according to claim 1 wherein each of the plurality of panel retainer assemblies comprises the biasing member.

5. A cover according to claim 1, wherein the panel comprises a stone panel.

6. A method of a replacing a first cover on a compartment with a second cover, the compartment including mounting hardware, the first cover including complementary hardware, the second cover including spring-loaded adjustable complementary hardware, the method comprising:
removing the first cover from the niche;
comparing the second cover to the first cover, releasing the spring-loaded adjustable complementary hardware of the second cover and adjusting the spring-loaded adjustable hardware of the second cover to match the complementary hardware of the first cover; and
placing the second cover on the compartment and securing the spring-loaded adjustable hardware to the mounting hardware of the compartment.

7. A method according to claim 6, wherein complementary mounting hardware of the first cover comprises a first retainer, and wherein the spring-loaded adjustable hardware of the second cover comprises a second retainer engaged and positioned by a spring, and wherein the adjusting comprises compressing the spring to release the second retainer and moving the second retainer to match a position of the first retainer.

8. A method according to claim 7, wherein the spring-loaded adjustable complementary hardware comprising a bracket having an orifice formed therein, the orifice having a width and a height greater than a height and width of the second retainer, the method comprising compressing the spring to release the second retainer moving the second retainer in the orifice to match the position of the first retainer.

9. A method according to claim 8, the orifice defining an axis, wherein the moving of the second retainer comprises moving the second retainer transversely to the axis.

10. A columbarium comprising:
a plurality of niches;
a plurality of facing panels including a complementary facing panel for each of the plurality of niches; at least one of the facing panels comprising:
an exposed front, and a back configured to face one of the plurality of niches;
a plurality of panel retainer assemblies, at least one of the panel retainer assemblies comprising:
a bracket mounted on the back of the facing panel; the bracket having a first side, a second side, and an orifice formed therein;
a retainer element, the retainer element having an engagement portion extending through the orifice of the bracket and projecting from a first side of the bracket, the retainer element being supported on the bracket spaced apart from the facing panel and extending substantially parallel to the back of the facing panel;
a biasing member on the second side of the bracket and engaging the bracket and the retainer element.
